(19) United States
(12) Patent Application Publication
(10) Pub. No.: US 2020/0327811 A1
(43) Pub. Date: Oct. 15, 2020

(54) DEVICES FOR AUTONOMOUS VEHICLE USER POSITIONING AND SUPPORT

(71) Applicant: UATC, LLC, San Francisco, CA (US)

(72) Inventors: Carol Jacobs Smith, Pittsburgh, PA (US); Michael Voznesensky, San Francisco, CA (US); Shenglong Gao, San Francisco, CA (US); Shubhit Mohan Singh, San Francisco, CA (US); Jacob Robert Forster, San Francisco, CA (US); Konrad Julian Niemiec, Mountain View, CA (US)

(21) Appl. No.: 16/849,586

(22) Filed: Apr. 15, 2020

Related U.S. Application Data
(60) Provisional application No. 62/834,337, filed on Apr. 15, 2019.

(51) Int. Cl. G08G 1/00; B60W 60/00; G08G 1/048; H04W 4/44; H04W 4/029

(52) U.S. Cl. CPC G08G 1/202; B60W 60/0011; H04W 4/029; G08G 1/048; H04W 4/44; G08G 1/205

(57) ABSTRACT

Various examples are directed to systems and methods for supporting an autonomous vehicle user. A user computing device may send a service arrangement system a service request describing a payload to be transported. The user computing device may receive from the service arrangement system, a service confirmation message describing a stopping location for a user to meet an autonomous vehicle and autonomous vehicle data describing the autonomous vehicle. The user computing device may also receive a first wireless signal from a first wireless beacon and determine a first location of the user computing device using the first wireless signal. The user computing device may display at a display of the user computing device, a direction from the first location of the user computing device to the stopping location.

### CLAIM FOR PRIORITY

This application claims the benefit of priority of U.S. Application Ser. No. 62/834,337, filed Apr. 15, 2019, which is hereby incorporated by reference in its entirety.

### FIELD

The document pertains generally, but not by way of limitation, to devices, systems, and methods for supporting the operations of autonomous vehicles and, for example, users of autonomous vehicles.

### BACKGROUND

An autonomous vehicle is a vehicle that is capable of sensing its environment and operating some or all of the vehicle's controls based on the sensed environment. An autonomous vehicle includes sensors that capture signals describing the environment surrounding the vehicle. The autonomous vehicle processes the captured sensor signals to comprehend the environment and automatically operates some or all of the vehicle's controls based on the resulting information.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 is a diagram showing one example of an environment utilizing wireless beacons to guide a user to one or more stopping locations, for example, to meet an autonomous vehicle.

FIG. 2 depicts a block diagram of an example vehicle according to example aspects of the present disclosure.

FIG. 3 is a flowchart showing one example of a process flow that may be executed by a user computing device in the environment to support the user of the autonomous vehicle.

FIG. 4 is a diagram showing one example of the user computing device displaying an example image including augmented reality (AR) elements.

FIG. 5 is a flowchart showing an example of a process flow that can be executed by the user computing device and the service arrangement system of in the environment of FIG. 1 to support the user of the autonomous vehicle.

FIG. 6 is a flowchart showing one example of a process flow that may be executed by a wireless beacon to provide wireless network access to the autonomous vehicle.

FIG. 7 is a flowchart showing an example process flow that may be executed by a wireless beacon to upload data utilizing a network connection of a second device.

FIG. 8 is a block diagram showing one example of a software architecture for a computing device.

FIG. 9 is a block diagram illustrating a computing device hardware architecture, within which a set or sequence of instructions can be executed to cause a machine to perform examples of any one of the methodologies discussed herein.

### DESCRIPTION

Examples described herein are directed to systems and methods for supporting autonomous vehicle users.

In an autonomous or semi-autonomous vehicle (collectively referred to as an autonomous vehicle (AV)), a vehicle autonomy system, sometimes referred to as an AV stack, controls one or more of braking, steering, or throttle of the vehicle. In a fully-autonomous vehicle, the vehicle autonomy system assumes full control of the vehicle. In a semi-autonomous vehicle, the vehicle autonomy system assumes a portion of the vehicle control, with a human user (e.g., a vehicle operator) still providing some control input.

A vehicle autonomy system can control an autonomous vehicle along a route from to a target location. A route is a path that the autonomous vehicle takes, or plans to take, over one or more roadways. In some examples, a route includes one or more stopping locations. A stopping location is a place where the autonomous vehicle can stop to pick-up or drop off one or more passengers and/or one or more pieces of cargo. Non-limiting examples of stopping locations include parking spots, driveways, roadway shoulders, and loading docks. A stopping location can also be referred to as a pick-up/drop-off zone (PDZ).

An autonomous vehicle can be used to transport a payload, for example. The payload may include one or more passengers and/or cargo. For example, the autonomous vehicle may provide a ride service that picks up one or more passengers at a first stopping location and drops off the one or more passengers at a second stopping location. In other examples, the autonomous vehicle may provide a cargo transport service that picks up cargo at a first stopping location and drops off the cargo at a second stopping location. Any suitable cargo can be transported including, for example, food or other items for delivery to a consumer.

Human users of the autonomous vehicle, including intended passengers and people who are to load cargo onto an autonomous vehicle, have a need to locate an autonomous vehicle at the stopping location where the autonomous vehicle is to pick up or drop off payload. An autonomous vehicle user can utilize a user computing device, such as a mobile phone or other similar device, to locate a stopping point where the user is to rendezvous with the autonomous vehicle. The user computing device can include a global positioning system (GPS) receiver or other suitable combination of hardware and software for locating the user. An application executing at the user computing device provides directions from the user's current location to the location of a stopping location for meeting the autonomous vehicle.

In some examples, however, a GPS receiver may not provide sufficient directions to allow the user to find the stopping location. For example, GPS has a limited accuracy and may not be able to adequately detect the location of the user relative to the stopping location and/or the user's speed and direction of travel. This can make it difficult to provide the user with specific directions for finding a stopping location. Challenges with GPS accuracy may be more acute in urban settings where tall buildings block GPS signals or in other locales including man-made and/or natural features that tend to block GPS signals.

Various embodiments described herein address these and other challenges by utilizing wireless beacons. The wireless beacons provide wireless locating signals that can be received by the user computing device. Wireless beacons can be placed in at or near a stopping location. A user computing device utilizes the wireless beacons to more accurately locate the user and, thereby, provide more accurate directions from the user's location to a desired stopping location.

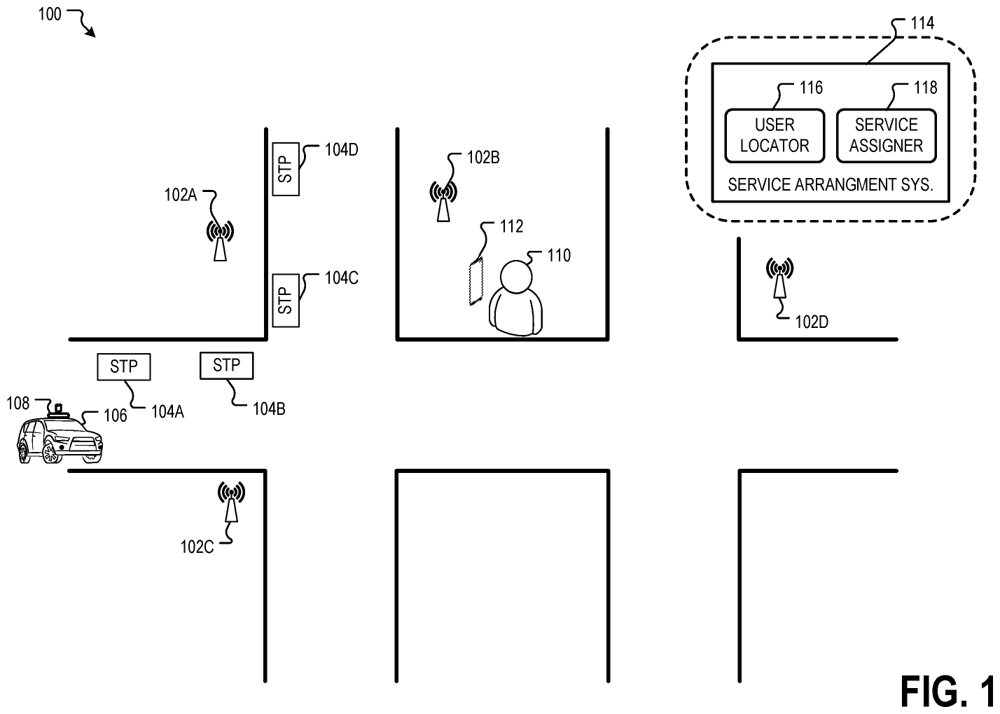

FIG. 1 is a diagram showing one example of an environment 100 utilizing wireless beacons 102A, 102B, 102C, 102D to guide a user 110 to one or more stopping locations 104A, 104B, 104C, 104D, for example, to meet an autonomous vehicle 106. The wireless beacons 102A, 102B, 102C, 102D emit a wireless signal, such as a wireless electromagnetic signal, an infrared signal, etc., that is detectable by a user computing device 112 of a user 110. The user computing device 112 may be or include any suitable type of computing device such as, for example, a mobile phone, a laptop computer, etc. The user computing device 112 utilizes the wireless signal from one or more of the wireless beacons 102A, 102B, 102C, 102D to determine a position the user computing device 112 and, therefore, also determine a position of the user 110.

The user computing device 112 may utilize the wireless signal from one or more of the wireless beacons 102A, 102B, 102C, 102D in any suitable manner. In some examples, the user computing device 112 receives wireless signals from multiple wireless beacons 102A, 102B, 102C, 102D and uses a triangulation technique to determine its location, for example, based on the signal strength of the multiple wireless signals. In other examples, the user computing device 112 directs the user 110 towards a stopping location 104A, 104B, 104C, 104D by leading the user 110 in a direction that increases the signal strength of a wireless beacon 102A, 102B, 102C, 102D. For example, a wireless beacon 102A, 102B, 102C, 102D can be positioned at or near a stopping location 104A, 104B, 104C, 104D such that moving towards a wireless beacon also means moving towards its associated stopping location 104A, 104B, 104C, 104D.

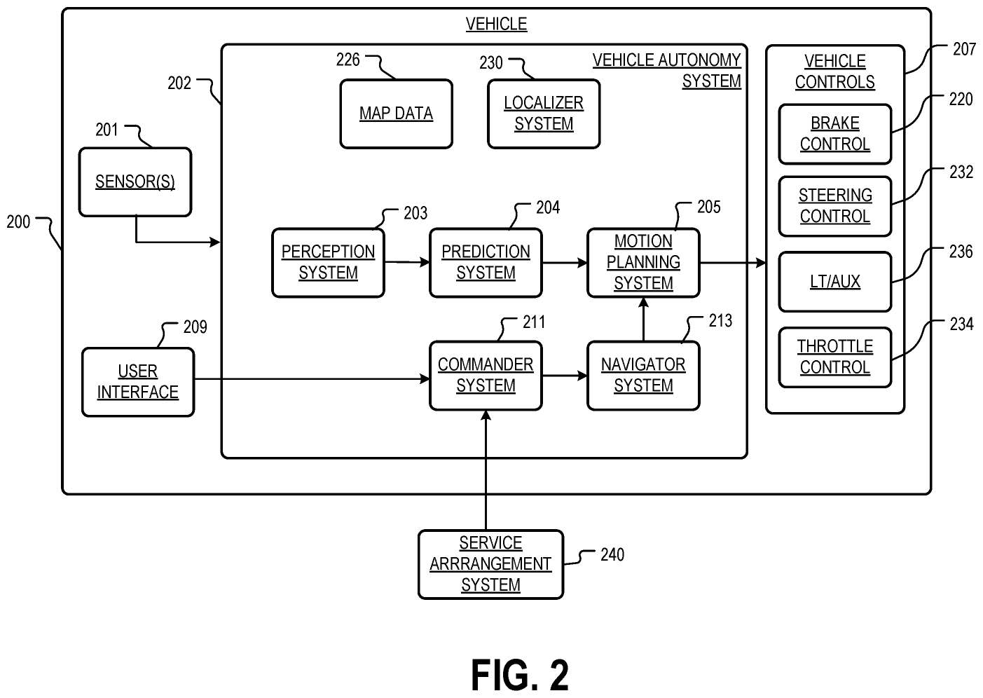

FIG. 1 shows an autonomous vehicle 106. The environment 100 includes an autonomous vehicle 106. The autonomous vehicle 106 can be a passenger vehicle such as a car, a truck, a bus, or other similar vehicle. The autonomous vehicle 106 can also be a delivery vehicle, such as a van, a truck, a tractor trailer, etc. The autonomous vehicle 106 is a self-driving vehicle (SDV) or autonomous vehicle (AV) including a vehicle autonomy system that is configured to operate some or all of the controls of the autonomous vehicle 106 (e.g., acceleration, braking, steering). The vehicle autonomy system is configured to perform route extension, as described herein. Further details of an example vehicle autonomy system are described herein with respect to FIG. 2.

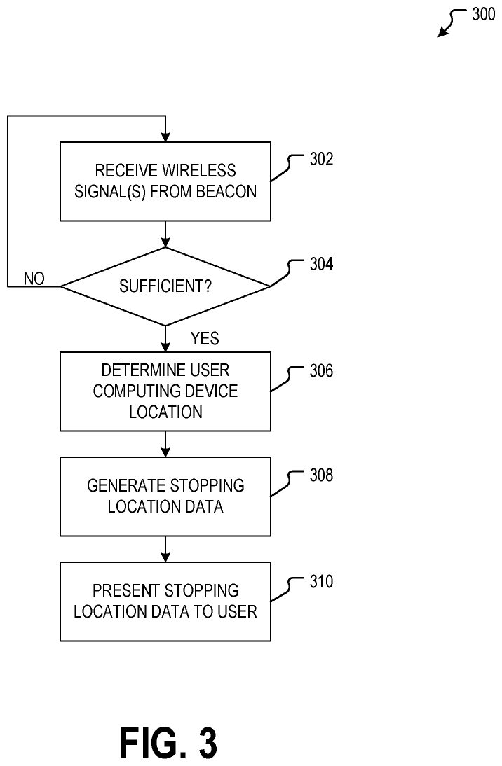

In some examples, the vehicle autonomy system is operable in different modes, where the vehicle autonomy system has differing levels of control over the autonomous vehicle 106 in different modes. In some examples, the vehicle autonomy system is operable in a full autonomous mode in which the vehicle autonomy system has responsibility for all or most of the controls of the autonomous vehicle 106. In addition to or instead of the full autonomous mode, the vehicle autonomy system, in some examples, is operable in a semi-autonomous mode in which a human user or driver is responsible for some or all of the control of the autonomous vehicle 106. Additional details of an example vehicle autonomy system are provided in FIG. 3.

The autonomous vehicle 106 has one or more remote-detection sensors 108 that receive return signals from the environment 100. Return signals may be reflected from objects in the environment 100, such as the ground, buildings, trees, etc. The remote-detection sensors 108 may include one or more active sensors, such as LIDAR, RADAR, and/or SONAR that emit sound or electromagnetic radiation in the form of light or radio waves to generate return signals. The remote-detection sensors 108 can also include one or more passive sensors, such as cameras or other imaging sensors, proximity sensors, etc., that receive return signals that originated from other sources of sound or electromagnetic radiation. Information about the environment 100 is extracted from the return signals. In some examples, the remote-detection sensors 108 include one or more passive sensors that receive reflected ambient light or other radiation, such as a set of monoscopic or stereoscopic cameras. Remote-detection sensors 108 provide remote sensor data that describes the environment 100. The autonomous vehicle 106 can also include other types of sensors, for example, as described in more detail with respect to FIG. 2.

FIG. 1 also shows an example service arrangement system 114 for assigning services to the autonomous vehicle 106 and, in some examples, to other vehicles not shown in FIG. 1. The service arrangement system 114 includes one or more computing devices, such as servers, that may be at a single physical location or networked across multiple physical locations.

The service arrangement system 114 comprises a service assigner subsystem 118 and a user locator subsystem 116. The service assigner subsystem 118 may receive requests for vehicle related services, for example, from users such as the user 110. Although one autonomous vehicle 106 and one user 110 are shown in FIG. 1, the service assigner subsystem 118 may be configured to assign services requested by multiple users to selected vehicles from a fleet of multiple vehicles. For example, the service assigner subsystem 118 may receive service requests from one or more users via one or more user computing devices. The service assigning subsystem 118 selects a vehicle, such as an autonomous vehicle, to complete the requested service, for example, by transporting payload as requested by the user. In some examples, the service assigning subsystem 118 also generates all or part of a route for the selected vehicle to complete the service. The service assigning subsystem 118 generates and sends a service confirmation message to the user computing device 112 of the requesting user 110. The service confirmation message includes autonomous vehicle data describing the autonomous vehicle 106 (e.g., color, license plate, etc.) and an indication of at least one stopping location 104A, 104B, 104C, 104D for meeting the autonomous vehicle 106.

When a service is assigned to a vehicle, such as the autonomous vehicle 106, the user 110 travels to a stopping location 104A, 104B, 104C, 104D where the autonomous vehicle 106 is to pick up the user 110 and/or cargo provided by the user 110. The user locator subsystem 116 provides service information to the user computing device 112 associated with the user 110. The service information includes, for example, identifying data describing the autonomous vehicle 106 that is to complete the service and also a stopping location 104A, 104B, 104C, 104D where the user 110 is to meet the autonomous vehicle 106.

The service assigner subsystem 118 may select one or more stopping locations 104A, 104B, 104C, 104D for a given service based on a target location for the service. The target location may be a location indicated by the user 110 where the user 110 is to meet the autonomous vehicle 106 selected for the service. The stopping locations 104A, 104B, 104C, 104D can be shoulders or curb-side areas on the city block where the autonomous vehicle 106 can pull-over. In some examples, the stopping locations 104A, 104B, 104C, 104D selected for a given target location are based on the direction of travel of the autonomous vehicle 106. For example, in the United States where traffic travels on the right-hand side of the roadway, stopping locations on the right-hand shoulder of the roadway relative to the autonomous vehicle 106 are associated with a target location, such as 112B, while stopping locations on the left-hand shoulder of the roadway may not, as it may not be desirable for the autonomous vehicle 106 to cross traffic to reach the left-hand shoulder of the roadway.

In some examples, the stopping locations 104A, 104B, 104C, 104D are at static locations. For example, each stopping location 104A, 104B, 104C, 104D may have fixed locations, for example, known to the service assigner subsystem 118 and/or user locator subsystem 116. In other examples, stopping locations 104A, 104B, 104C, 104D are dynamic. For example, the service assigner subsystem 118 or other suitable system, may select stopping locations 104A, 104B, 104C, 104D for a requested service based on various factors such as, current roadway conditions, current traffic, current weather, etc.

The user computing device 112 may provide a user interface to the user 110 that includes directions from the current location of the user 110 and user computing device 112 to the indicated stopping location 104A, 104B, 104C, 104D. The user computing device 112 receives one or more wireless signals from one or more wireless beacons 102A, 102B, 102C, 102D. The user computing device 112 utilizes the one or more wireless signals to determine a location of the user 110. The location determined from the wireless signal can replace and/or supplement other location devices at the user computing device 112 such as, GPS, etc.

The user computing device 112 can be configured to provide a user interface to the user 110, for example, at a screen of the user computing device 112. The user interface can include a graphical representation showing the user 110 how to proceed to reach the relevant stopping location 104A, 104B, 104C, 104D. In some examples, the user interface comprises a map showing a path between the user's current location and the relevant stopping location 104A, 104B, 104C, 104D. In other examples, the user computing device 112 includes a camera. The user computing device 112 may instruct the user to hold up the device and display an output of the camera on a screen of the user computing device 112. The user computing device 112 may plot an arrow or other visual indicator over the image captured by the camera to show the user 110 how to move towards the relevant stopping location 104A, 104B, 104C, 104D. For example, if the user 110 holds the user computing device with the camera pointing directly ahead of the user 110, the arrow may point in the direction that the user 110 should go to reach the stopping location 104A, 104B, 104C, 104D. In some examples, the plotting of an arrow or other visual indicator over an image captured by the user computing device 112 is referred to as augmented reality (AR).

The wireless beacons 102A, 102B, 102C, 102D may be static or dynamic. In some examples, the wireless beacons 102A, 102B, 102C, 102D are at fixed locations along roadways. In some examples, there is a one-to-one correlation between a wireless beacon 102A, 102B, 102C, 102D and a stopping location 104A, 104B, 104C, 104D.

Dynamic wireless beacons 102A, 102B, 102C, 102D can be implemented in various different ways. In some examples, one or more wireless beacons 102A, 102B, 102C, 102D are implemented on a vehicle, such as the autonomous vehicle 106, a drone or similar aerial vehicle, etc. The user locator subsystem 116 may track the location of dynamic wireless beacons 102A, 102B, 102C, 102D and provide current location information to the user computing device 112. In some examples, in addition to or instead of the user locator subsystem 116 tracking the location of a dynamic wireless beacon 102A, 102B, 102C, 102D, the wireless beacon 102A, 102B, 102C, 102D itself tracks its location and provides an indication of the location with the wireless signal. The user computing device 112 uses the current location information in conjunction with the wireless signal received from the wireless beacon or beacons 102A, 102B, 102C, 102D to determine the location of the user 110 and provide directions to the relevant stopping location 104A, 104B, 104C, 104D.

With a dynamic wireless beacon 102A, 102B, 102C, 102D, the location of the beacon may change as the beacon moves. Accordingly, the user computing device 112 may receive wireless signals from the same wireless beacon 102A, 102B, 102C, 102D that indicate different locations. The user computing device 112 may, in some examples, use the beacon location indicated by the most recently-received wireless signal to determine its own location.

In some examples, the autonomous vehicle 106 includes a wireless beacon 102A, 102B, 102D. As the autonomous vehicle 106 approaches a designated stopping location 104A, 104B, 104C, 104D, the wireless beacon 102A, 102B, 102C, 102D associated with the autonomous vehicle 106 generates a wireless signal that is received by the user computing device 112. The wireless signal, in some examples, includes a location generated by or using sensors in the autonomous vehicle 106. The user computing device 112 uses the location indicated by the wireless signal as the location of the wireless beacon 102A, 102B, 102C, 102D for locating the user 110 and generating directions to the relevant stopping location 104A, 104B, 104C, 104D.

In some examples, one or more of the wireless beacons 102A, 102B, 102C, 102D includes sensors, such as remote-detection sensors. Remote detection sensors at a wireless beacon 102A, 102B, 102C, 102D can be used to detect roadway conditions at or near the wireless beacon 102A, 102B, 102C, 102D. For example, remote-detection sensors at a wireless beacon 102A, 102B, 102C, 102D may detect traffic conditions, weather conditions, or other detectable roadway conditions. Data describing roadway conditions can be provided to the service arrangement system 114, which may use the roadway condition data, for example, to assign services to vehicles, to select vehicles for executing services, and/or for any other suitable purpose. In some examples, the service arrangements system 114 is configured to extrapolate roadway conditions detected at one or more wireless beacons 102A, 102B, 102C, 102D. For example, roadway conditions between the wireless beacons 102D and wireless beacons 102C and 102D may be estimated by extrapolating roadway conditions reported by wireless beacons 102B, 102C, and 102D.

In some examples, remote-detection sensors at one or more wireless beacons 102A, 102B, 102C, 102D are used to determine whether a stopping location 104A, 104B, 104C, 104D is available. A stopping location 104A, 104B, 104C, 104D can be available for stopping or unavailable for stopping. A stopping location 104A, 104B, 104C, 104D is available for stopping if there is space at the stopping location 104A, 104B, 104C, 104D for the autonomous vehicle 106 to stop and pick-up or drop-off a payload (e.g., passenger(s) and/or cargo). For example, a single-vehicle parking spot is available for stopping if no other vehicle is present. A roadway shoulder location is available for stopping if there is an unoccupied portion of the roadway shoulder that is large enough to accommodate the autonomous vehicle.

In some applications, the vehicle autonomy system of the autonomous vehicle 106 does not know if a particular stopping location is available until the stopping location is within the range of the vehicle's remote-detection sensors 108. Stopping location availability data generated by wireless beacons 102A, 102B, 102C, 102D can be provided to the autonomous vehicle 106, for example, allowing the autonomous vehicle 106 to select an available stopping location 104A, 104B, 104C, 104D. In addition to or instead of providing the stopping location availability data to the autonomous vehicle 106, one or more wireless beacons 102A, 102B, 102C, 102D can be configured to provide stopping location availability data to the service arrangement system 114. The service arrangement system 114 is configured to utilize the stopping location availability data to select a vehicle for a given service. For example, if only smaller stopping locations are available are the pick-up location desired by the user 110, the service arrangement system 114 may select a smaller autonomous vehicle 106 for the service.

Remote-detection sensors at wireless beacons 102A, 102B, 102C, 102D may also be used to detect the autonomous vehicle 106 at a stopping location 104A, 104B, 104C, 104D. For example, remote detection sensors at a wireless beacon 102A, 102B, 102D can be configured to capture images or other data describing one or more stopping locations 104A, 104B, 104C, 104D. A system in the environment 100 such as, for example, the user computing device 112 and/or the service arrangement system 114 is configured to analyze the captured images or other data and, when it is present, identify the autonomous vehicle 106 at the stopping location 104A, 104B, 104C, 104D. The autonomous vehicle 106 may be identified, for example, by color, by a license plate number, and/or by any other identifiable feature. The presence or absence of the autonomous vehicle 106 at the relevant stopping location 104A, 104B, 104C, 104D can be detected from the image or other data by the user computing device 112, the service arrangement system 114, the vehicle autonomy system of the autonomous vehicle 106 and/or by any other suitable system. In some examples, the user computing device 112 provides an alert to the user 110 when the autonomous vehicle 106 is detected at the relevant stopping location 104A, 104B, 104C, 104D.

In some examples, the wireless beacons 102A, 102B, 102C, 102D provide wireless network access to the user computing device according to a suitable wireless standards such as, for example, Bluetooth, Bluetooth LE, Wi-Fi (e.g., a suitable IEEE 802.11 standard), or any other suitable standard. In some examples, the wireless signal provided by a wireless beacon 102A, 102B, 102C, 102D is provided via the wireless communication standard. Providing the user computing device 112 with wireless network access may allow the user computing device 112 to communicate with the service arrangement system 114, check e-mail, browse the Internet, or utilize other suitable network services while in-range. For example, the wireless network access may be provided while the user 110 is waiting for the autonomous vehicle 106 to arrive.

FIG. 2 depicts a block diagram of an example vehicle 200 according to example aspects of the present disclosure. The vehicle 200 includes one or more sensors 201, a vehicle autonomy system 202, and one or more vehicle controls 207. The vehicle 200 can be an autonomous vehicle, as described herein.

The vehicle autonomy system 202 includes a commander system 211, a navigator system 213, a perception system 203, a prediction system 204, a motion planning system 205, and a localizer system 230 that cooperate to perceive the surrounding environment of the vehicle 200 and determine a motion plan for controlling the motion of the vehicle 200 accordingly.

The vehicle autonomy system 202 is engaged to control the vehicle 200 or to assist in controlling the vehicle 200. In particular, the vehicle autonomy system 202 receives sensor data from the one or more sensors 201, attempts to comprehend the environment surrounding the vehicle 200 by performing various processing techniques on data collected by the sensors 201, and generates an appropriate route through the environment. The vehicle autonomy system 202 sends commands to control the one or more vehicle controls 207 to operate the vehicle 200 according to the route.

Various portions of the vehicle autonomy system 202 receive sensor data from the one or more sensors 201. For example, the sensors 201 may include remote-detection sensors as well as motion sensors such as an inertial measurement unit (IMU), one or more encoders, or one or more odometers. The sensor data can include information that describes the location of objects within the surrounding environment of the vehicle 200, information that describes the motion of the vehicle 200, etc.

The sensors 201 may also include one or more remote-detection sensors or sensor systems, such as a LIDAR, a RADAR, one or more cameras, etc. As one example, a LIDAR system of the one or more sensors 201 generates sensor data (e.g., remote-detection sensor data) that includes the location (e.g., in three-dimensional space relative to the LIDAR system) of a number of points that correspond to objects that have reflected a ranging laser. For example, the LIDAR system can measure distances by measuring the Time of Flight (TOF) that it takes a short laser pulse to travel from the sensor to an object and back, calculating the distance from the known speed of light.

As another example, a RADAR system of the one or more sensors 201 generates sensor data (e.g., remote-detection sensor data) that includes the location (e.g., in three-dimensional space relative to the RADAR system) of a number of points that correspond to objects that have reflected ranging radio waves. For example, radio waves (e.g., pulsed or continuous) transmitted by the RADAR system can reflect off an object and return to a receiver of the RADAR system, giving information about the object's location and speed. Thus, a RADAR system can provide useful information about the current speed of an object.

As yet another example, one or more cameras of the one or more sensors 201 may generate sensor data (e.g., remote sensor data) including still or moving images. Various processing techniques (e.g., range imaging techniques such as, for example, structure from motion, structured light, stereo triangulation, and/or other techniques) can be performed to identify the location (e.g., in three-dimensional space relative to the one or more cameras) of a number of points that correspond to objects that are depicted in an image or images captured by the one or more cameras. Other sensor systems can identify the location of points that correspond to objects as well.

As another example, the one or more sensors 201 can include a positioning system. The positioning system determines a current position of the vehicle 200. The positioning system can be any device or circuitry for analyzing the position of the vehicle 200. For example, the positioning system can determine a position by using one or more of inertial sensors, a satellite positioning system such as a Global Positioning System (GPS), based on IP address, by using triangulation and/or proximity to network access points or other network components (e.g., cellular towers, Wi-Fi access points) and/or other suitable techniques. The position of the vehicle 200 can be used by various systems of the vehicle autonomy system 202.

Thus, the one or more sensors 201 can be used to collect sensor data that includes information that describes the location (e.g., in three-dimensional space relative to the vehicle 200) of points that correspond to objects within the surrounding environment of the vehicle 200. In some implementations, the sensors 201 can be positioned at various different locations on the vehicle 200.

As an example, in some implementations, one or more cameras and/or LIDAR sensors can be located in a pod or other structure that is mounted on a roof of the vehicle 200 while one or more RADAR sensors can be located in or behind the front and/or rear bumper(s) or body panel(s) of the vehicle 200. As another example, camera(s) can be located at the front or rear bumper(s) of the vehicle 200. Other locations can be used as well.

The localizer system 230 receives some or all of the sensor data from sensors 201 and generates vehicle poses for the vehicle 200. A vehicle pose describes the position and attitude of the vehicle 200. The vehicle pose (or portions thereof) can be used by various other components of the vehicle autonomy system 202 including, for example, the perception system 203, the prediction system 204, the motion planning system 205 and the navigator system 213.

The position of the vehicle 200 is a point in a three-dimensional space. In some examples, the position is described by values for a set of Cartesian coordinates, although any other suitable coordinate system may be used. The attitude of the vehicle 200 generally describes the way in which the vehicle 200 is oriented at its position. In some examples, attitude is described by a yaw about the vertical axis, a pitch about a first horizontal axis, and a roll about a second horizontal axis. In some examples, the localizer system 230 generates vehicle poses periodically (e.g., every second, every half second). The localizer system 230 appends time stamps to vehicle poses, where the time stamp for a pose indicates the point in time that is described by the pose. The localizer system 230 generates vehicle poses by comparing sensor data (e.g., remote sensor data) to map data 226 describing the surrounding environment of the vehicle 200.

In some examples, the localizer system 230 includes one or more pose estimators and a pose filter. Pose estimators generate pose estimates by comparing remote-sensor data (e.g., LIDAR, RADAR) to map data. The pose filter receives pose estimates from the one or more pose estimators as well as other sensor data such as, for example, motion sensor data from an IMU, encoder, or odometer. In some examples, the pose filter executes a Kalman filter or machine learning algorithm to combine pose estimates from the one or more pose estimators with motion sensor data to generate vehicle poses. In some examples, pose estimators generate pose estimates at a frequency less than the frequency at which the localizer system 230 generates vehicle poses. Accordingly, the pose filter generates some vehicle poses by extrapolating from a previous pose estimate utilizing motion sensor data.

Vehicle poses and/or vehicle positions generated by the localizer system 230 can be provided to various other components of the vehicle autonomy system 202. For example, the commander system 211 may utilize a vehicle position to determine whether to respond to a call from a service arrangement system 240.

The commander system 211 determines a set of one or more target locations that are used for routing the vehicle 200. The target locations can be determined based on user input received via a user interface 209 of the vehicle 200. The user interface 209 may include and/or use any suitable input/output device or devices. In some examples, the commander system 211 determines the one or more target locations considering data received from the service arrangement system 240. The service arrangement system 240 can be programmed to provide instructions to multiple vehicles, for example, as part of a fleet of vehicles for moving passengers and/or cargo. Data from the service arrangement system 240 can be provided via a wireless network, for example.

The navigator system 213 receives one or more target locations from the commander system 211 or user interface 209 along with map data 226. Map data 226, for example, may provide detailed information about the surrounding environment of the vehicle 200. Map data 226 can provide information regarding identity and location of different roadways and segments of roadways (e.g., lane segments). A roadway is a place where the vehicle 200 can drive and may include, for example, a road, a street, a highway, a lane, a parking lot, or a driveway.

From the one or more target locations and the map data 226, the navigator system 213 generates route data describing a route for the vehicle to take to arrive at the one or more target locations. The navigator system 213, in some examples, also generates route data describing route extensions, as described herein.

In some implementations, the navigator system 213 determines route data or route data based on applying one or more cost functions and/or reward functions for each of one or more candidate routes for the vehicle 200. For example, a cost function can describe a cost (e.g., a time of travel) of adhering to a particular candidate route while a reward function can describe a reward for adhering to a particular candidate route. For example, the reward can be of a sign opposite to that of cost. Route data is provided to the motion planning system 205, which commands the vehicle controls 207 to implement the route or route extension, as described herein.

The perception system 203 detects objects in the surrounding environment of the vehicle 200 based on sensor data, map data 226 and/or vehicle poses provided by the localizer system 230. For example, map data 226 used by the perception system may describe roadways and segments thereof and may also describe: buildings or other items or objects (e.g., lampposts, crosswalks, curbing); location and directions of traffic lanes or lane segments (e.g., the location and direction of a parking lane, a turning lane, a bicycle lane, or other lanes within a particular roadway); traffic control data (e.g., the location and instructions of signage, traffic lights, or other traffic control devices); and/or any other map data that provides information that assists the vehicle autonomy system 202 in comprehending and perceiving its surrounding environment and its relationship thereto.

In some examples, the perception system 203 determines state data for one or more of the objects in the surrounding environment of the vehicle 200. State data describes a current state of an object (also referred to as features of the object). The state data for each object describes, for example, an estimate of the object's: current location (also referred to as position); current speed (also referred to as velocity); current acceleration; current heading; current orientation; size/shape/footprint (e.g., as represented by a bounding shape such as a bounding polygon or polyhedron); type/class (e.g., vehicle versus pedestrian versus bicycle versus other); yaw rate; distance from the vehicle 200; minimum path to interaction with the vehicle 200; minimum time duration to interaction with the vehicle 200; and/or other state information.

In some implementations, the perception system 203 can determine state data for each object over a number of iterations. In particular, the perception system 203 updates the state data for each object at each iteration. Thus, the perception system 203 detects and tracks objects, such as vehicles, that are proximate to the vehicle 200 over time.

The prediction system 204 is configured to predict one or more future positions for an object or objects in the environment surrounding the vehicle 200 (e.g., an object or objects detected by the perception system 203). The prediction system 204 generates prediction data associated with one or more of the objects detected by the perception system 203. In some examples, the prediction system 204 generates prediction data describing each of the respective objects detected by the prediction system 204.

Prediction data for an object can be indicative of one or more predicted future locations of the object. For example, the prediction system 204 may predict where the object will be located within the next 5 seconds, 20 seconds, 200 seconds, etc. Prediction data for an object may indicate a predicted trajectory (e.g., predicted path) for the object within the surrounding environment of the vehicle 200. For example, the predicted trajectory (e.g., path) can indicate a path along which the respective object is predicted to travel over time (and/or the speed at which the object is predicted to travel along the predicted path). The prediction system 204 generates prediction data for an object, for example, based on state data generated by the perception system 203. In some examples, the prediction system 204 also considers one or more vehicle poses generated by the localizer system 230 and/or map data 226.

In some examples, the prediction system 204 uses state data indicative of an object type or classification to predict a trajectory for the object. As an example, the prediction system 204 can use state data provided by the perception system 203 to determine that a particular object (e.g., an object classified as a vehicle) approaching an intersection and maneuvering into a left-turn lane intends to turn left. In such a situation, the prediction system 204 predicts a trajectory (e.g., path) corresponding to a left-turn for the vehicle 200 such that the vehicle 200 turns left at the intersection. Similarly, the prediction system 204 determines predicted trajectories for other objects, such as bicycles, pedestrians, parked vehicles, etc. The prediction system 204 provides the predicted trajectories associated with the object(s) to the motion planning system 205.

In some implementations, the prediction system 204 is a goal-oriented prediction system 204 that generates one or more potential goals, selects one or more of the most likely potential goals, and develops one or more trajectories by which the object can achieve the one or more selected goals. For example, the prediction system 204 can include a scenario generation system that generates and/or scores the one or more goals for an object, and a scenario development system that determines the one or more trajectories by which the object can achieve the goals. In some implementations, the prediction system 204 can include a machine-learned goal-scoring model, a machine-learned trajectory development model, and/or other machine-learned models.

The motion planning system 205 commands the vehicle controls based at least in part on the predicted trajectories associated with the objects within the surrounding environment of the vehicle 200, the state data for the objects provided by the perception system 203, vehicle poses provided by the localizer system 230, map data 226, and route data provided by the navigator system 213. Stated differently, given information about the current locations of objects and/or predicted trajectories of objects within the surrounding environment of the vehicle 200, the motion planning system 205 determines control commands for the vehicle 200 that best navigate the vehicle 200 along the route or route extension relative to the objects at such locations and their predicted trajectories on acceptable roadways.

In some implementations, the motion planning system 205 can also evaluate one or more cost functions and/or one or more reward functions for each of one or more candidate control commands or sets of control commands for the vehicle 200. Thus, given information about the current locations and/or predicted future locations/trajectories of objects, the motion planning system 205 can determine a total cost (e.g., a sum of the cost(s) and/or reward(s) provided by the cost function(s) and/or reward function(s)) of adhering to a particular candidate control command or set of control commands. The motion planning system 205 can select or determine a control command or set of control commands for the vehicle 200 based at least in part on the cost function(s) and the reward function(s). For example, the motion plan that minimizes the total cost can be selected or otherwise determined.

In some implementations, the motion planning system 205 can be configured to iteratively update the route or route extension for the vehicle 200 as new sensor data is obtained from one or more sensors 201. For example, as new sensor data is obtained from one or more sensors 201, the sensor data can be analyzed by the perception system 203, the prediction system 204, and the motion planning system 205 to determine the motion plan.

The motion planning system 205 can provide control commands to one or more vehicle controls 207. For example, the one or more vehicle controls 207 can include throttle systems, brake systems, steering systems, and other control systems, each of which can include various vehicle controls (e.g., actuators or other devices that control gas flow, steering, braking) to control the motion of the vehicle 200. The various vehicle controls 207 can include one or more controllers, control devices, motors, and/or processors.

The vehicle controls 207 can include a brake control module 220. The brake control module 220 is configured to receive a braking command and bring about a response by applying (or not applying) the vehicle brakes. In some examples, the brake control module 220 includes a primary system and a secondary system. The primary system receives braking commands and, in response, brakes the vehicle 200. The secondary system may be configured to determine a failure of the primary system to brake the vehicle 200 in response to receiving the braking command.

A steering control system 232 is configured to receive a steering command and bring about a response in the steering mechanism of the vehicle 200. The steering command is provided to a steering system to provide a steering input to steer the vehicle 200.

A lighting/auxiliary control module 236 receives a lighting or auxiliary command. In response, the lighting/auxiliary control module 236 controls a lighting and/or auxiliary system of the vehicle 200. Controlling a lighting system may include, for example, turning on, turning off, or otherwise modulating headlines, parking lights, running lights, etc. Controlling an auxiliary system may include, for example, modulating windshield wipers, a defroster, etc.

A throttle control system 234 is configured to receive a throttle command and bring about a response in the engine speed or other throttle mechanism of the vehicle. For example, the throttle control system 234 can instruct an engine and/or engine controller, or other propulsion system component to control the engine or other propulsion system of the vehicle 200 to accelerate, decelerate, or remain at its current speed.

Each of the perception system 203, the prediction system 204, the motion planning system 205, the commander system 211, the navigator system 213, and the localizer system 230, can be included in or otherwise a part of a vehicle autonomy system 202 configured to control the vehicle 200 based at least in part on data obtained from one or more sensors 201. For example, data obtained by one or more sensors 201 can be analyzed by each of the perception system 203, the prediction system 204, and the motion planning system 205 in a consecutive fashion in order to control the vehicle 200. While FIG. 2 depicts elements suitable for use in a vehicle autonomy system according to example aspects of the present disclosure, one of ordinary skill in the art will recognize that other vehicle autonomy systems can be configured to control an autonomous vehicle based on sensor data.

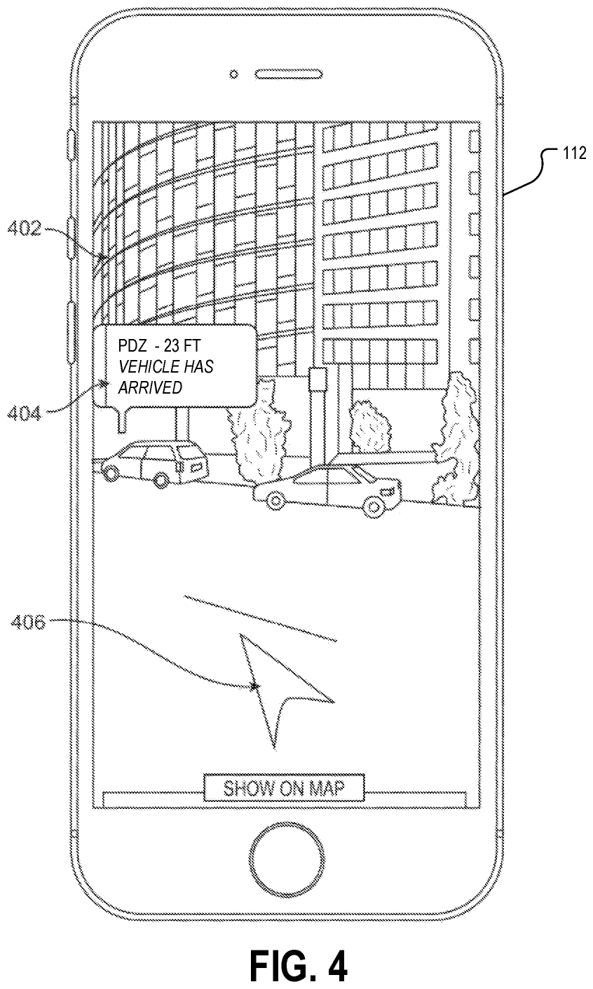

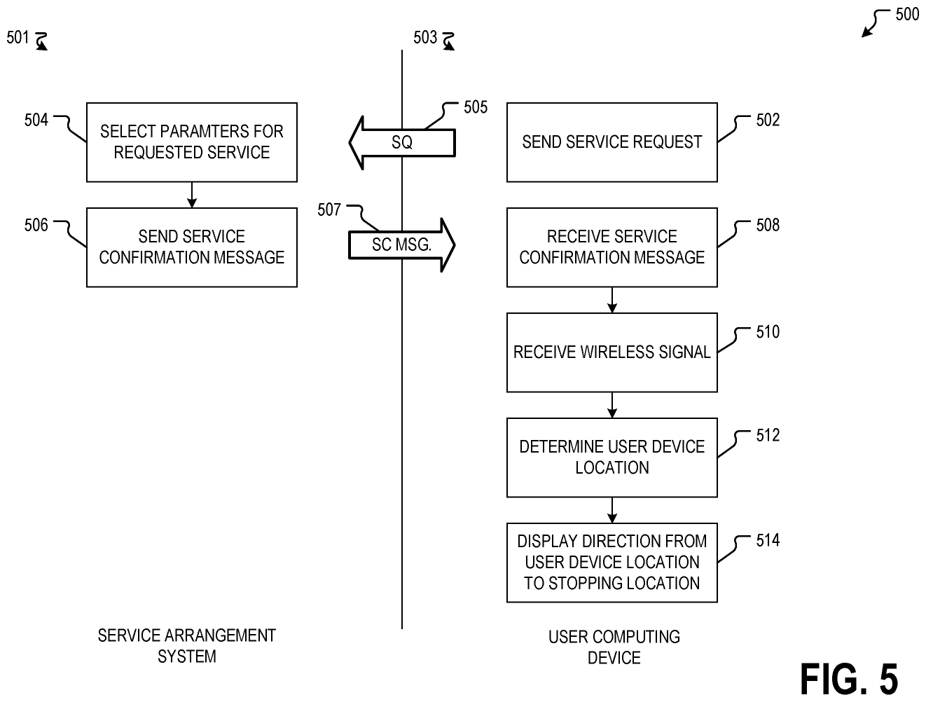

The vehicle autonomy system 202 includes one or more computing devices, which may implement all or parts of the perception system 203, the prediction system 204, the motion planning system 205 and/or the localizer system 230. Descriptions of hardware and software configurations for computing devices to implement the vehicle autonomy system 202 and/or the vehicle autonomy system are provided herein at FIGS. 4 and 5.

FIG. 3 is a flowchart showing one example of a process flow 300 that may be executed by a user computing device 112 in the environment 100 to support the user 110 of the autonomous vehicle 106. At operation 302, the user computing device 112 receives one or more wireless signals from one or more wireless beacons 102A, 102B, 102C, 102D. The wireless signal or signals, as described herein, may include an indication of the location of the corresponding wireless beacon 102A, 102B, 102C, 102D that generated the respective wireless signal or signals. In some examples, the wireless signal includes data identifying the wireless beacon 102A, 102B, 102C, 102D. For example, if the wireless signal does not indicate the location of the originating wireless beacon 102A, 102B, 102C, 102D, the user computing device 112 may use the data identifying the wireless beacon 102A, 102B, 102C, 102D to query the service arrangement system 114 or other suitable source to receive the location of identified wireless beacon 102A, 102B, 102C, 102D.

At operation 304, the user computing device 112 determines whether the wireless signal or signals received at operation 302 are sufficient to determine a location of the user computing device 112. In some examples, wireless signals from three different wireless beacons 102A, 102B, 102C, 102D are sufficient to determine a location of the user computing device 112 using triangulation, as described herein. In some instances, the user computing device 112 may be able to determine its location based on wireless signals from two different wireless beacons 102A, 102B, 102C, 102D. For example, the user computing device 112 may be able to utilize wireless signals from two different wireless beacons 102A, 102B, 102C, 102D to determine two possible locations for the device 112. If the two possible locations are separated by a distance that is greater than the error associated with GPS or other suitable location sensors at the user computing device 112, the user computing device 112 may utilize GPS or other suitable location sensors to select an actual location from the two possible locations.

At operation 306, the user computing device 112 determines its location using the wireless signals received at operation 302. If wireless signals from at least three wireless beacons 102A, 102B, 102C, 102D are received, the user computing device 112 uses triangulation to determine its location from the at least three wireless signals. In some examples, as described herein, the user computing device 112 receives two wireless signals from two wireless beacons 102A, 102B, 102C, 102D and derives two potential locations. Another location sensor at the user computing device 112 may be used to select an actual location from among the two potential locations.

At operation 308, the user computing device 112 utilizes the location determined at operation 306 to generate stopping location data. The stopping location data describes the stopping location 104A, 104B, 104C, 104D where the autonomous vehicle 106 is to stop and pick up the user 110 and/or the user's cargo. In some examples, the stopping location data includes directions to the stopping location 104A, 104B, 104C, 104D from the current location of the user computing device 112, as determined at operation 306. In some examples, the stopping location data includes an image of the stopping location 104A, 104B, 104C, 104D. The user computing device 112 may select the image of the stopping location 104A, 104B, 104C, 104D using the location of the user computing device 112. For example, the user computing device 112 may select an image of the stopping location 104A, 104B, 104C, 104D from the direction that the user 110 will approach the stopping location 104A, 104B, 104C, 104D. In some examples, the stopping location data includes AR data that can be superimposed over an image captured by the user computing device 112 to direct the user 110 to the stopping location 104A, 104B, 104C, 104D. At operation 310, the user computing device 112 provides the stopping location data to the user 110, for example, using a display or other output device of the user computing device 112.

FIG. 4 is a diagram showing one example of the user computing device 112 displaying an example image 402 including AR elements. The image 402 is captured by a camera or other suitable image sensor of the user computing device 112. In this example, AR elements included in the mage identify a stopping location where the autonomous vehicle 106 has stopped to pick up the user 110 and/or the user's cargo. The image 402 is overlaid by graphical and textual elements intended to identify the stopping location, including a text box 404. In the example, of FIG. 4, the text box 404 indicates the stopping location for the user 110 (called a PDZ in the image). In the example of FIG. 4, the text box 404 also indicates other stopping location data including, for example, the distance between the user computing device 112 and the stopping location (e.g., 23 feet in this example, and that the autonomous vehicle 106 has arrived at the stopping location. The distance between the user computing device 112 and the stopping location can be determined using the location of the user computing device 112 that is determined as described herein. The computing device 112 may determine that the autonomous vehicle 106 has arrived at the stopping location, for example, using data received from a wireless beacon 102A, 102B, 102C, 102D near the stopping location. For example, the wireless beacon 102A, 102B, 102C, 102D near the stopping location may determine that the autonomous vehicle 106 has arrived and provide to the user computing device 112 an indication that the autonomous vehicle 106 has arrived. In some examples, the image 402 also includes graphical and/or textual elements that are intended to aid the user 110 in navigating to the stopping location. For example, the image 402 includes an arrow 406 pointing to the stopping location. In some examples, the arrow 406 and/or other suitable navigational aids are displayed on images where the stopping location is not depicted, for example, if the user 110 is too far from the stopping location to capture it in the image 402 and/or if the user 110 is pointing the user computing device 112 away from the stopping location.

The user computing device 112 may locate the stopping location and/or generate navigational aids, such as the arrow 406 utilizing the location of the user computing device 112, determined at least in part using wireless beacons 102A, 102B, 102C, 102D as well as, for example, the geographic location of the stopping location, a direction in which the computing device 112 image sensor is pointing, and/or a tilt of the user computing device 112, for example, as determined from a motion sensor or other suitable sensor of the user computing device 112.

In some examples, the use of the user computing device 112 location determined from wireless beacon signals decreases the latency for generating AR elements, such as those shown in FIG. 4. For example, the user computing device 112 may not need to communicate with a remote server to determine its own location and/or the location of a stopping location 104A, 104B, 104C, 104D. This may allow the user computing device 112 to generate and/or update AR elements faster and/or at a higher frequency that would be achieved if the user computing device 112 were to wait on a remote server, such as the service arrangement system 114, to provide information about stopping locations 104A, 104B, 104C, 104D, the location of the user computing device 112, and/or the relationship therebetween.

FIG. 5 is a flowchart showing an example of a process flow 500 that can be executed by the user computing device 112 and the service arrangement system 114 in the environment 100 to support the user 110 of the autonomous vehicle 106. The flowchart of FIG. 5 includes two columns. A column 501 shows operations executed by the service arrangement system 114. A column 503 shows operations executed by the user computing device 112.

At operation 502, the user computing device 112 sends a service request 505 to the service arrangement system 114. The service request 505 describes a transportation service desired by the user 110 of the user computing device. For example, the service request 505 may describe a payload to be transported (e.g., one or more passengers, one or more items of cargo). The service request 505 may also describe a pick-up location where the payload will be picked-up and a drop-off location where the payload is to be dropped off.

The service arrangement system 114 receives the service request 505 and, at operation 504, selects parameters for fulfilling the requested transportation service. This can include, for example, selecting an autonomous vehicle 106 for executing the requested transportation service. The autonomous vehicle 106 may be selected, for example, based on its ability to carry the requested payload, its location relative to the pick-up location, its ability to execute a route from its location to the pick-up location and then to the drop-off location, an estimated time when it will arrive at the pick-up location, an estimated time when it will arrive at the drop-off location, or other suitable factors.

The service arrangement system 114 may also select one or more stopping locations at or near the pick-up location where the selected autonomous vehicle 106 will pick-up the user 110 and/or the user's cargo. In some examples, the selection of the one or more stopping locations is based on stopping location availability data generated by one or more wireless beacons 102A, 102B, 102C, 102D. For example, the service arrangement system 114 may selects one or more stopping locations 104A, 104B, 104C, 104D that are currently unoccupied.

At operation 506, the service arrangement system 114 sends a service confirmation message 507 to the user computing device 112. The service confirmation message 507 includes, for example, an indication of the selected autonomous vehicle 106 and an indication of a stopping location where the vehicle will pick-up the payload. The user computing device 112 receives the service confirmation message 507 at operation 508.

At operation 510, the user computing device 112 receives one or more wireless signals from one or more wireless beacons 102A, 102B, 102C, 102D. As described herein, the user computing device 112 utilizes the received wireless signals to determine its location at operation 512. At operation 514, the user computing device 112 displays a direction from the location of the user computing device 112 determined at operation 512 to the stopping location indicated by the service confirmation message 507. This can include, for example, verbal instructions provided via audio, textual directions, a map showing the location of the user computing device 112 and the location of the stopping location, AR elements, or data in any other suitable format.

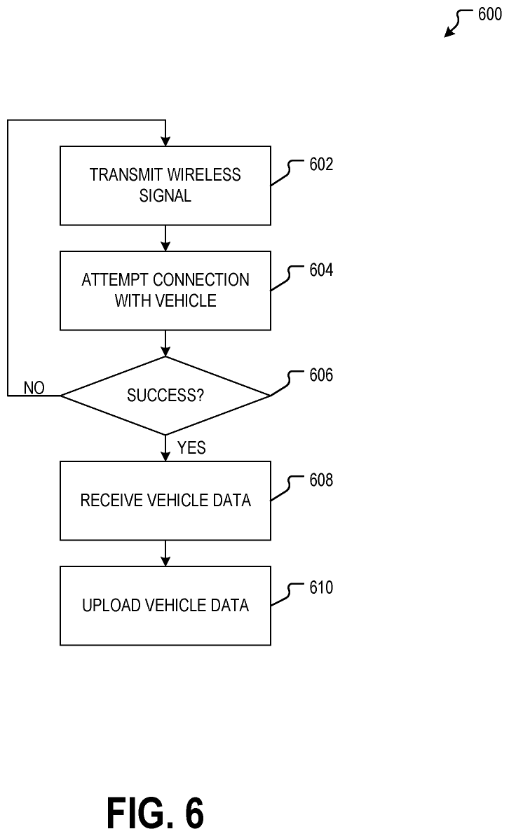

FIG. 6 is a flowchart showing one example of a process flow 600 that may be executed by a wireless beacon 102A, 102B, 102C, 102D to provide wireless network access to the autonomous vehicle 106. For example, a wireless beacon 102A, 102B, 102C, 102D may have a network connection, such as an Internet connection, that is faster and/or less expensive than the network connection of the autonomous vehicle 106. As described herein, wireless beacons 102A, 102B, 102C, 102D may be positioned near stopping locations 104A, 104B, 104C, 104D. In some examples, the autonomous vehicle 106 is programmed to perform high-bandwidth tasks at or near the stopping locations 104A, 104B, 104C, 104D. High-bandwidth tasks are tasks performed by the autonomous vehicle 106 that utilize a high level of network bandwidth.

One example task includes performing pre or post-service cabin check tasks. Pre or post-service cabin check tasks involve capturing high definition video data from the interior of the autonomous vehicle 106. For example, a pre-service cabin check may determine that the cabin of the autonomous vehicle 106 is in a suitable condition to perform the service (e.g., there is no damage, there are no objects obstructing a seat or cargo area, etc.). A post-service cabin check may determine that the previous user has exited the autonomous vehicle 106 and has not left any payload at the vehicle. To perform a pre or post-service cabin check, the autonomous vehicle 106 may capture high-definition images and/or video of its cabin and provide the images and/or video to the service arrangement system 114.

Another example task includes teleoperator assistance. During teleoperator assistance, the autonomous vehicle 106 provides vehicle status data (e.g., data from remote-detection sensors 108, one or more vehicle poses determined by a localizer system, etc.) to a remote teleoperator, who may be a human user. Based on the provided data, the remote teleoperator provides one or more instructions to the autonomous vehicle 106. Some teleoperator assistance tasks take place near stopping locations 104A, 104B, 104C, 104D.

The process flow 600 illustrates one way that a wireless beacon 102A, 102B, 102C, 102D with a faster and/or less expensive network access than the autonomous vehicle 106 can assist the autonomous vehicle 106 in performing high-bandwidth tasks. At operation 602, the wireless beacon 102A, 102B, 102C, 102D transmits a wireless signal. The wireless signal may indicate the location of the wireless beacon 102A, 102B, 102C, 102D, as described herein. At operation 604, the wireless beacon 102A, 102B, 102C, 102D may attempt to establish a network connection with the autonomous vehicle 106. The wireless beacon 102A, 102B, 102C, 102D may attempt to establish the network connection on its own and/or in response to a request from the autonomous vehicle 106. The connection may be according to any suitable wireless format such as, for example, Bluetooth, Bluetooth LE, Wi-Fi (e.g., a suitable IEEE 802.11 standard), or any other suitable standard.

At operation 606, the wireless beacon 102A, 102B, 102C, 102D determines if it has successfully established a connection with the autonomous vehicle 106. If not, the wireless beacon 102A, 102B, 102C, 102D may continue to transmit the wireless signal at operation 602 and attempt a vehicle connection at operation 604.

If the wireless beacon 102A, 102B, 102C, 102D has successfully connected to the autonomous vehicle 106, it may receive vehicle data at operation 608. The vehicle data may include any suitable data from the autonomous vehicle 106 that is to be uploaded, for example, the service arrangement system 114. In some examples, the vehicle data includes high definition video or images captured as part of a pre or post-service cabin check. In some examples, the vehicle data includes vehicle status data that is to be provided to a teleoperator. At operation 610, the wireless beacon 102A, 102B, 102C, 102D uploads the received vehicle data, for example, to the service arrangement system 114. In addition to or instead of uploading vehicle data, the wireless beacon 102A, 102B, 102C, 102D may also download data to the vehicle such as, for example, teleoperator instructions, map updates, etc.

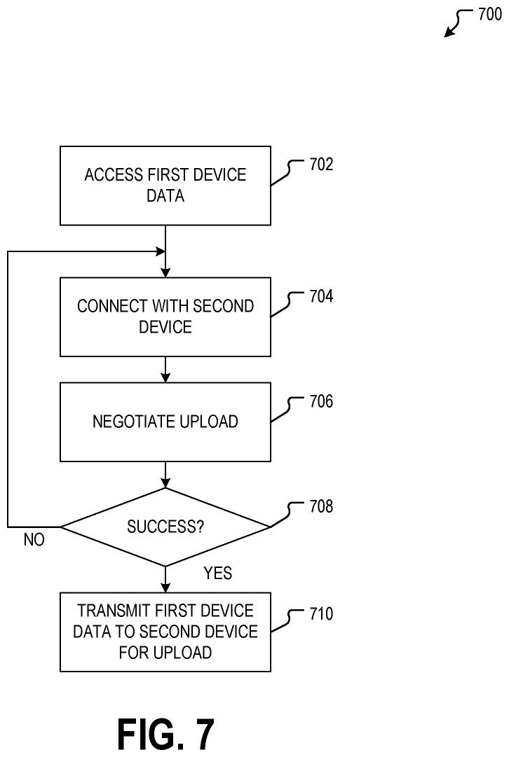

FIG. 7 is a flowchart showing an example process flow 700 that may be executed by a wireless beacon 102A, 102B, 102C, 102D to upload data utilizing a network connection of a second device. For example, the process flow 700 may be executed by one or more wireless beacons 102A, 102B, 102C, 102D that do not have a network connection that is faster and/or less expensive than those of the vehicles 106.

At operation 702, the wireless beacon 102A, 102B, 102C, 102D accesses first device data. In some examples, the first device data is generated by the wireless beacon 102A, 102B, 102C, 102D and can include, for example, stopping location availability data, traffic conditions, weather conditions, or other roadway conditions, as described herein. In other examples, the first device data is generated by another device, such as the autonomous vehicle 106, and provided to the wireless beacon 102A, 102B, 102C, 102D. For example, the wireless beacon 102A, 102B, 102C, 102D may receive vehicle data from an autonomous vehicle, such as the autonomous vehicle 106. The vehicle data may be similar to the vehicle data described herein with respect to the process flow 600.

At operation 704, the wireless beacon 102A, 102B, 102C, 102D connects with a second device, such as the user computing device 112 and/or an autonomous vehicle, such as the autonomous vehicle 106. The second device may have a wired or wireless network connection that can be used to upload the vehicle data, for example, to the service arrangement system 114. For example, the user computing device 112 may connect to the wireless beacon 102A, 102B, 102C, 102D upon receiving the wireless signal from the wireless beacon 102A, 102B, 102C, 102D used to locate the user computing device 112.

At operation 706, the wireless beacon 102A, 102B, 102C, 102D negotiates an upload with the second device. This can include, for example, providing the second device with an indication of the vehicle data to be uploaded including, for example, the size of the data, a recipient or recipients for the data, a time when the data is to be uploaded, etc. In some examples, the second device may reply by either accepting the parameters provided by the wireless beacon 102A, 102B, 102C, 102D and/or provide a counteroffer. The counteroffer may include, for example, a different upload time, an offer for less than all of the vehicle data, etc. In some examples, the second accepts an upload at a time when it is on a less-expensive and/or non-metered network.

At operation 708, the wireless beacon 102A, 102B, 102C, 102D determines if an upload has been successfully negotiated. If not, then wireless beacon 102A, 102B, 102C, 102D may connect to a different device at operation 704. If an upload is successfully negotiated, then the wireless beacon 102A, 102B, 102C, 102D transmits the first device data to the second device for upload at operation 710.

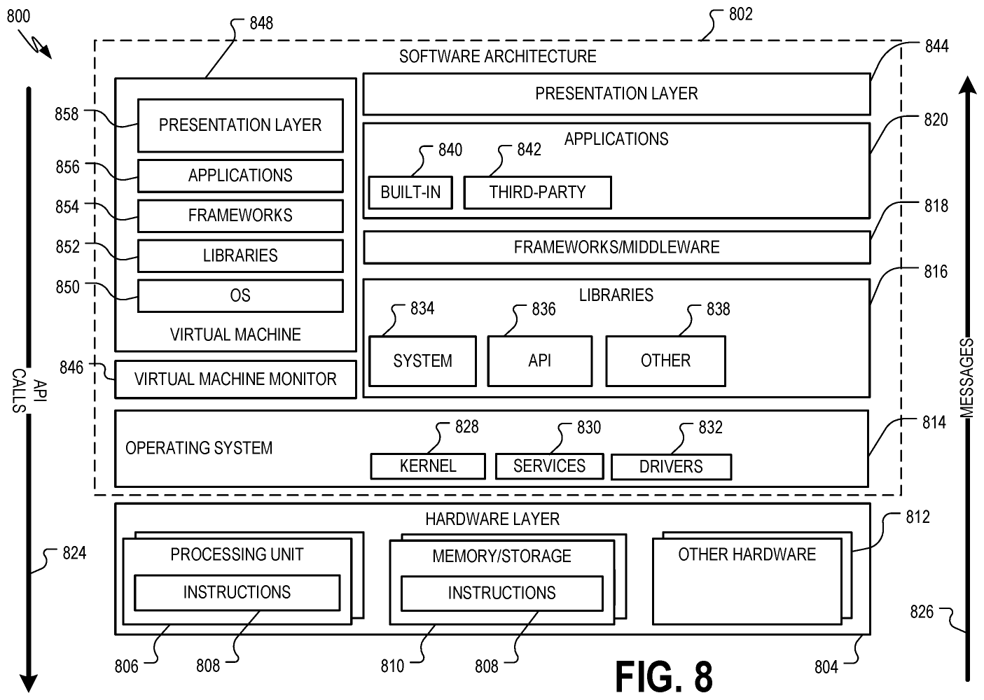

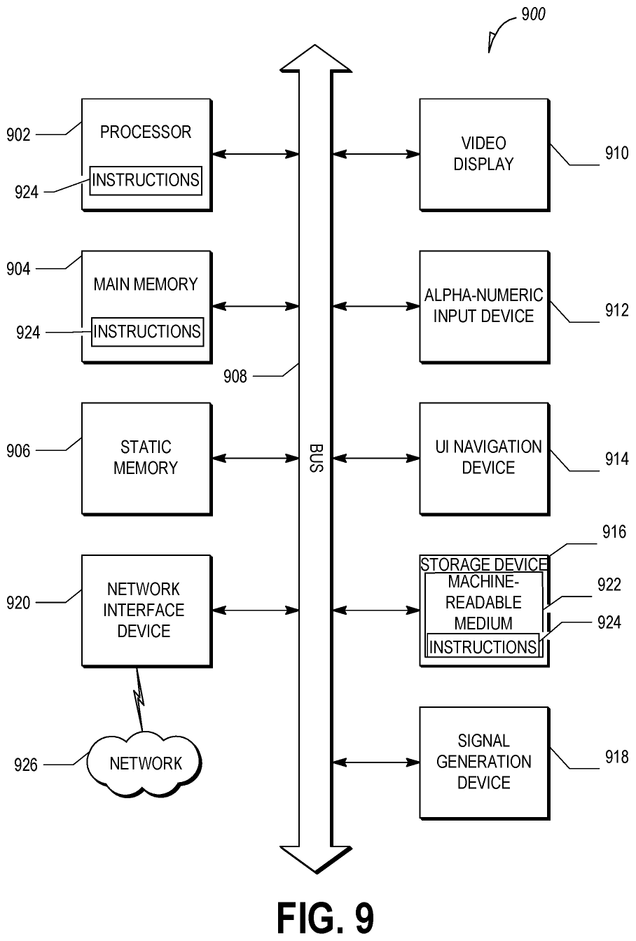

FIG. 8 is a block diagram 800 showing one example of a software architecture 802 for a computing device. The software architecture 802 may be used in conjunction with various hardware architectures, for example, as described herein. FIG. 8 is merely a non-limiting example of a software architecture 802 and many other architectures may be implemented to facilitate the functionality described herein. A representative hardware layer 804 is illustrated and can represent, for example, any of the above-referenced computing devices. In some examples, the hardware layer 804 may be implemented according to an architecture 900 of FIG. 9 and/or the software architecture 802 of FIG. 8.

The representative hardware layer 804 comprises one or more processing units 806 having associated executable instructions 808. The executable instructions 808 represent the executable instructions of the software architecture 802, including implementation of the methods, modules, components, and so forth of FIGS. 1-7. The hardware layer 804 also includes memory and/or storage modules 810, which also have the executable instructions 808. The hardware layer 804 may also comprise other hardware 812, which represents any other hardware of the hardware layer 804, such as the other hardware illustrated as part of the architecture 900.

In the example architecture of FIG. 8, the software architecture 802 may be conceptualized as a stack of layers where each layer provides particular functionality. For example, the software architecture 802 may include layers such as an operating system 814, libraries 816, frameworks/middleware 818, applications 820, and a presentation layer 844. Operationally, the applications 820 and/or other components within the layers may invoke API calls 824 through the software stack and receive a response, returned values, and so forth illustrated as messages 826 in response to the API calls 824. The layers illustrated are representative in nature and not all software architectures have all layers. For example, some mobile or special-purpose operating systems may not provide a frameworks/middleware 818 layer, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. In some examples, the services 830 include an interrupt service. The interrupt service may detect the receipt of a hardware or software interrupt and, in response, cause the software architecture 802 to pause its current processing and execute an ISR when an interrupt is received. The ISR may generate an alert.

The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), WiFi® drivers, NFC drivers, audio drivers, power management drivers, and so forth depending on the hardware configuration.

The libraries 816 may provide a common infrastructure that may be used by the applications 820 and/or other components and/or layers. The libraries 816 typically provide functionality that allows other software modules to perform tasks in an easier fashion than by interfacing directly with the underlying operating system 814 functionality (e.g., kernel 828, services 830, and/or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 8D graphic content on a display), database libraries (e.g., SQLite that may provide various relational database functions), web libraries (e.g., WebCT that may provide web browsing functionality), and the like. The libraries 816 may also include a wide variety of other libraries 838 to provide many other APIs to the applications 820 and other software components/modules.

The frameworks 818 (also sometimes referred to as middleware) may provide a higher-level common infrastructure that may be used by the applications 820 and/or other software components/modules. For example, the frameworks 818 may provide various graphical user interface (GUI) functions, high-level resource management, high-level location services, and so forth. The frameworks 818 may provide a broad spectrum of other APIs that may be used by the applications 820 and/or other software components/modules, some of which may be specific to a particular operating system or platform.

The applications 820 include built-in applications 840 and/or third-party applications 842. Examples of representative built-in applications 840 may include, but are not limited to, a contacts application, a browser application, a book reader application, a location application, a media application, a messaging application, and/or a game application. The third-party applications 842 may include any of the built-in applications 840 as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 842 may invoke the API calls 824 provided by the mobile operating system such as the operating system 814 to facilitate functionality described herein.

The applications 820 may use built-in operating system functions (e.g., kernel 828, services 830, and/or drivers 832), libraries (e.g., system libraries 834, API libraries 836, and other libraries 838), or frameworks/middleware 818 to create user interfaces to interact with users of the system. Alternatively, or additionally, in some systems, interactions with a user may occur through a presentation layer, such as the presentation layer 844. In these systems, the application/module “logic” can be separated from the aspects of the application/module that interact with a user.

Some software architectures use virtual machines. For example, systems described herein may be executed using one or more virtual machines executed at one or more server computing machines. In the example of FIG. 8, this is illustrated by a virtual machine 848. A virtual machine creates a software environment where applications/modules can execute as if they were executing on a hardware computing device. The virtual machine 848 is hosted by a host operating system (e.g., the operating system 814) and typically, although not always, has a virtual machine monitor 846, which manages the operation of the virtual machine 848 as well as the interface with the host operating system (e.g., the operating system 814). A software architecture executes within the virtual machine 848, such as an operating system 850, libraries 852, frameworks/middleware 854, applications 856, and/or a presentation layer 858. These layers of software architecture executing within the virtual machine 848 can be the same as corresponding layers previously described or may be different.

FIG. 9 is a block diagram illustrating a computing device hardware architecture 900, within which a set or sequence of instructions can be executed to cause a machine to perform examples of any one of the methodologies discussed herein. The hardware architecture 900 describes a computing device for executing the vehicle autonomy system, described herein.

The architecture 900 may operate as a standalone device or may be connected (e.g., networked) to other machines. In a networked deployment, the architecture 900 may operate in the capacity of either a server or a client machine in server-client network environments, or it may act as a peer machine in peer-to-peer (or distributed) network environments. The architecture 900 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 900 includes a processor unit 902 comprising at least one processor (e.g., a central processing unit (CPU), a graphics processing unit (GPU), or both, processor cores, compute nodes). The architecture 900 may further comprise a main memory 904 and a static memory 906, which communicate with each other via a link 908 (e.g., bus). The architecture 900 can further include a video display unit 910, an input device 912 (e.g., a keyboard), and a UI navigation device 914 (e.g., a mouse). In some examples, the video display unit 910, input device 912, and UI navigation device 914 are incorporated into a touchscreen display. The architecture 900 may additionally include a storage device 916 (e.g., a drive unit), a signal generation device 918 (e.g., a speaker), a network interface device 920, and one or more sensors (not shown), such as a Global Positioning System (G) sensor, compass, accelerometer, or other sensor.

In some examples, the processor unit 902 or another suitable hardware component may support a hardware interrupt. In response to a hardware interrupt, the processor unit 902 may pause its processing and execute an ISR, for example, as described herein.

The storage device 916 includes a non-transitory machine-readable medium 922 on which is stored one or more sets of data structures and instructions 924 (e.g., software) embodying or used by any one or more of the methodologies or functions described herein. The instructions 924 can also reside, completely or at least partially, within the main memory 904, within the static memory 906, and/or within the processor unit 902 during execution thereof by the architecture 900, with the main memory 904, the static memory 906, and the processor unit 902 also constituting machine-readable media.

Executable Instructions and Machine-Storage Medium

The various memories (i.e., 904, 906, and/or memory of the processor unit(s) 902) and/or storage device 916 may store one or more sets of instructions and data structures (e.g., instructions) 924 embodying or used by any one or more of the methodologies or functions described herein. These instructions, when executed by processor unit(s) 902 cause various operations to implement the disclosed examples.

As used herein, the terms “machine-storage medium,” “device-storage medium,” “computer-storage medium” (referred to collectively as “machine-storage medium 922”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 922 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 922 specifically exclude carrier waves, modulated data signals, and other such media, at least some of which are covered under the term “signal medium” discussed below.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 924 can further be transmitted or received over a communications network 926 using a transmission medium via the network interface device 920 using any one of a number of well-known transfer protocols (e.g., HTTP). Examples of communication networks include a LAN, a WAN, the Internet, mobile telephone networks, plain old telephone service (POTS) networks, and wireless data networks (e.g., Wi-Fi, 3G, 4G LTE/LTE-A, 5G or WiMAX networks). The term “transmission medium” shall be taken to include any intangible medium that is capable of storing, encoding, or carrying instructions for execution by the machine, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other examples can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as examples can feature a subset of said features. Further, examples can include fewer features than those disclosed in a particular example. Thus, the following claims are hereby incorporated into the Detailed Description, with each claim standing on its own as a separate example. The scope of the examples disclosed herein is to be determined with reference to the appended claims, along with the full scope of equivalents to which such claims are entitled.

1. A system for supporting an autonomous vehicle user, comprising:
a user computing device comprising at least one processor and a machine-readable medium comprising instructions thereon that, when executed by the at least one processor, causes the at least one processor to perform operations comprising:
sending to a service arrangement system a service request describing a payload to be transported;
receiving, from the service arrangement system, a service confirmation message describing a stopping location for a user to meet an autonomous vehicle and autonomous vehicle data describing the autonomous vehicle;
receiving a first wireless signal from a first wireless beacon;
determining a first location of the user computing device using the first wireless signal; and
displaying at a display of the user computing device, a direction from the first location of the user computing device to the stopping location.

2. The system of claim 1, wherein the first wireless signal comprises location data indicating a location of the first wireless beacon.

3. The system of claim 1, the operations further comprising receiving from the service arrangement system a first wireless beacon location for the first wireless beacon, wherein the determining of the first location of the user computing device is also based at least in part on the first wireless beacon location.

4. The system of claim 3, wherein the first wireless beacon location is received at a first time, the operations further comprising
receiving a second wireless beacon location of the first wireless beacon, the second wireless beacon location received at a second time after the first time; and
receiving a second wireless signal from the first wireless beacon after receiving the first wireless signal; and
generating a second location of the user computing device based at least in part on the second wireless beacon location and the second wireless signal.

5. The system of claim 1, further comprising the service arrangement system, the service arrangement system programmed to perform operations comprising:
receiving the service request;
selecting the autonomous vehicle for executing a service described by the service request;
accessing an indication of a stopping location for the autonomous vehicle, the stopping location associated with the service; and
sending the service confirmation message to the user computing device.

6. The system of claim 5, the operations executed by the service arrangement system further comprising receiving roadway condition data from the first wireless beacon, wherein the selecting of the autonomous vehicle is based at least in part on the roadway condition data.

7. The system of claim 5, the operations executed by the service arrangement system further comprising:
receiving, from the first wireless beacon, data indicating that the autonomous vehicle is present at the stopping location; and
sending to the user computing device an indication that the autonomous vehicle is present at the stopping location.

8. The system of claim 5, the operations executed by the service arrangement system further comprising:
receiving stopping location availability data from at least one wireless beacon; and
selecting the stopping location based at least in part on the stopping location availability data.

9. The system of claim 1, wherein the first wireless signal indicates that the autonomous vehicle is present at the stopping location.

10. The system of claim 1, the operations further comprising:
receiving vehicle data from the first wireless beacon; and
uploading the vehicle data to the service arrangement system.

11. The system of claim 1, further comprising the first wireless beacon, the first wireless beacon being programmed to perform operations comprising:
accessing first device data; and
transmitting the first device data to a second device for uploading to the service arrangement system.

12. A method for supporting an autonomous vehicle user, comprising:
sending, by a user computing device to a service arrangement system, a service request describing a payload to be transported;
receiving, by the user computing device and from the service arrangement system, a service confirmation message describing a stopping location for a user to meet an autonomous vehicle and autonomous vehicle data describing the autonomous vehicle;
receiving, by the user computing device, a first wireless signal from a first wireless beacon;
determining, by the user computing device, a first location of the user computing device using the first wireless signal; and
displaying at a display of the user computing device, a direction from the first location of the user computing device to the stopping location.

13. The method of claim 12, wherein the first wireless signal comprises location data indicating a location of the first wireless beacon.

14. The method of claim 12, further comprising receiving, by the user computing device and from the service arrangement system, a first wireless beacon location for the first wireless beacon, wherein the determining of the first location of the user computing device is also based at least in part on the first wireless beacon location.

15. The method of claim 14, wherein the first wireless beacon location is received at a first time, further comprising
receiving, by the user computing device, a second wireless beacon location of the first wireless beacon, the second wireless beacon location received at a second time after the first time; and
receiving, by the user computing device, a second wireless signal from the first wireless beacon after receiving the first wireless signal; and
generating, by the user computing device, a second location of the user computing device based at least in part on the second wireless beacon location and the second wireless signal.

16. The method of claim 12, wherein the first wireless signal indicates that the autonomous vehicle is present at the stopping location.

17. The method of claim 12, further comprising:
receiving, by the user computing device, vehicle data from the first wireless beacon; and
uploading, by the user computing device, the vehicle data to the service arrangement system.

18. A machine-readable medium comprising instructions thereon that, when executed by at least one processor, cause the at least one processor to perform operations comprising:
sending to a service arrangement system a service request describing a payload to be transported;
receiving, from the service arrangement system, a service confirmation message describing a stopping location for a user to meet an autonomous vehicle and autonomous vehicle data describing the autonomous vehicle;
receiving a first wireless signal from a first wireless beacon;
determining a first location of a user computing device using the first wireless signal; and
displaying at a display of the user computing device, a direction from the first location of the user computing device to the stopping location.

19. The medium of claim 18, wherein the first wireless signal comprises location data indicating a location of the first wireless beacon.

20. The medium of claim 18, the operations further comprising receiving from the service arrangement system a first wireless beacon location for the first wireless beacon, wherein the determining of the first location of the user computing device is also based at least in part on the first wireless beacon location.
